(19) United States
(12) Patent Application Publication
(10) Pub. No.: US 2024/0331934 A1
(43) Pub. Date: Oct. 3, 2024

(54) COIL DEVICE

(71) Applicant: TDK CORPORATION, Tokyo (JP)

(72) Inventors: Hideaki HARATA, Tokyo (JP); Shoichi TANI, Tokyo (JP); Hiroki IDANI, Tokyo (JP); Keiichi YASUHARA, Tokyo (JP)

(73) Assignee: TDK CORPORATION, Tokyo (JP)

(21) Appl. No.: 18/596,729

(22) Filed: Mar. 6, 2024

(30) Foreign Application Priority Data
Mar. 31, 2023 (JP) 2023-058409

(51) Int. Cl. H01F 27/32; H01F 27/26; H01F 27/29

(52) U.S. Cl. CPC H01F 27/325; H01F 27/266; H01F 27/29

(57) ABSTRACT

A coil device, including a bobbin including a tubular part, a wire wound around the tubular part, a cover capable of being installed on the bobbin, and a core including a middle leg part. The cover includes an end wall having an end wall opening arranged at an end part of the tubular part so as to connect with a through hole of the tubular part, and a first engagement part engaging with the bobbin. The middle leg part is arranged so as to be inserted into the end wall opening and the through hole.

### BACKGROUND

The present invention relates to a coil device such as a transformer.

In order to correspond to higher pressure resistance of coil devices, an insulation cover may be placed between a bobbin and a core in some cases to achieve high-pressure resistance of the coil devices (for example, see Patent Document 1). Such coil devices are designed so that the insulation cover is assembled with the bobbin, and then the core is further assembled.

However, during the assembling of the coil device, the bobbin and the insulation cover are not fixed, hence it is difficult to determine the positions, and also the assembling property is low. Also, the bobbin, the insulation cover, and the core are adhered on a core upper part, however, the bonding strength between these are not sufficient, hence, improved strength reliability of the coil device is demanded.
[Patent Document 1] JP Patent Application Laid Open No. 2008-187052

### SUMMARY

The present invention is achieved in view of such circumstances, and the object is to provide a coil device having an excellent assembling property and an excellent strength reliability.

In order to achieve such object, the coil device according to a preferable embodiment of the present invention includes:
a bobbin including a tubular part;
a wire wound around the tubular part;
a cover capable of being installed on the bobbin; and
a core including a middle leg part, wherein the cover includes an end wall having an end wall opening arranged at an end part of the tubular part so as to connect with a through hole of the tubular part, and a first engagement part engaging with the bobbin; and
the middle leg part is arranged so as to be inserted into the end wall opening and the through hole

By configuring as such, when the cover is installed on the bobbin, the first engagement part of the cover fit to the bobbin. Therefore, for example, when the bobbin, on which the cover has been installed, is transferred, it becomes difficult to release the cover from the bobbin, thus the assembling property improves. Also, the position of the end wall opening of the cover and the through hole of the bobbin are aligned, hence it becomes easy to install the core in the end wall opening and the through hole. Thus, the assembling property is improved from this point as well. Also, due to the first engagement part, the cover is fit and fixed to the bobbin; and for example, by adhering the core and the bobbin together with the first engagement part using an adhesive agent, the adhesive strength between the cover, the bobbin, and the core is improved, hence, the strength reliability of the coil device is improved.

Preferably, the tubular part includes a flange at the end part, and
the flange includes a second engagement part engaging with the first engagement part.

By taking such configuration, the assembling property further improves, and also the strength reliability of the coil device further improves.

Preferably, the second engagement part includes a raised part projecting from an end face of the flange.

By configuring as such, the assembling property is further improved, and also the strength reliability of the coil device is further improved.

Preferably, the raised part includes a slanted face which deforms the first engagement part and guides the first engagement part along the slanted face, and
a hook part for latching the first engagement part.

When installing the cover on the bobbin, the first engagement part of the cover resiliently deforms and the first engagement part is guided along the slanted face of the raised part, and the first engagement part returns to its original form and automatically latches to the hook part. Therefore, the cover fits to the bobbin. Thus, the assembling property further improves and the strength reliability of the coil device also further improves.

Preferably, the first engagement part is arranged on the end wall having the end wall opening.

By configuring as such, it becomes easier for the first engagement part to deform resiliently, and the cover can fit to the bobbin easily in a one-touch manner. Therefore, the assembling property is further improved, and also the strength reliability of the coil device is further improved.

Preferably, the first engagement part includes claw-like parts projecting inwards to the end wall opening from an opening edge of the end wall, and the claw-like parts are positioned on both sides in a width direction of the through hole of the tubular part.

By configuring as such, it becomes easier to resiliently deform the claw-like part as the first engagement part, and the cover can be easily fit to the bobbin in a one-touch manner. Therefore, the assembling property further improves, and the strength reliability of the coil device further improves.

Preferably, the end wall opening is separated into a main opening and a sub-opening by the claw-like parts, and
the middle leg is inserted into the main opening.

By configuring as such, the position of the main opening of the cover and the position of through hole of the bobbin can be aligned further accurately, hence, the middle leg part of the core can be easily inserted into the main opening and the through hole. Therefore, the assembling property is further improved and the strength reliability of the coil device is also further improved.

Preferably, the first engagement part is fixed to the bobbin and to the core using an adhesive.

By configuring as such, the first engagement part can be reinforced, each member strongly adheres with each other, and an impact resistance is improved, thus, the strength reliability of the coil device is further improved.

Preferably, the bobbin includes a terminal block for installing a terminal connected to a lead part pulled out from a coil part of the wire, and
the cover includes a terminal block cover part covering the terminal block.

Due to the terminal block cover part of the cover, an insulation length between the terminal and the core becomes longer, and an insulation resistance improves.

### BRIEF DESCRIPTION DRAWINGS

FIG. 1 is a perspective diagram of a coil device according to one embodiment of the present disclosure.

FIG. 2 is an exploded perspective diagram of the coil device a shown in FIG. 1.

FIG. 3 is a perspective diagram showing a configuration of a bobbin of the coil device shown in FIG. 1.

FIG. 4 is a perspective diagram showing a configuration of a cover of the coil device shown in FIG. 1.

FIG. 5 is a perspective diagram showing a core and a tape of the coil device shown in FIG. 1.

FIG. 6 is a front view which is a condition of the coil device shown in FIG. 1 prior to installing the core.

FIG. 7 is a front view of the coil device shown in FIG. 1.

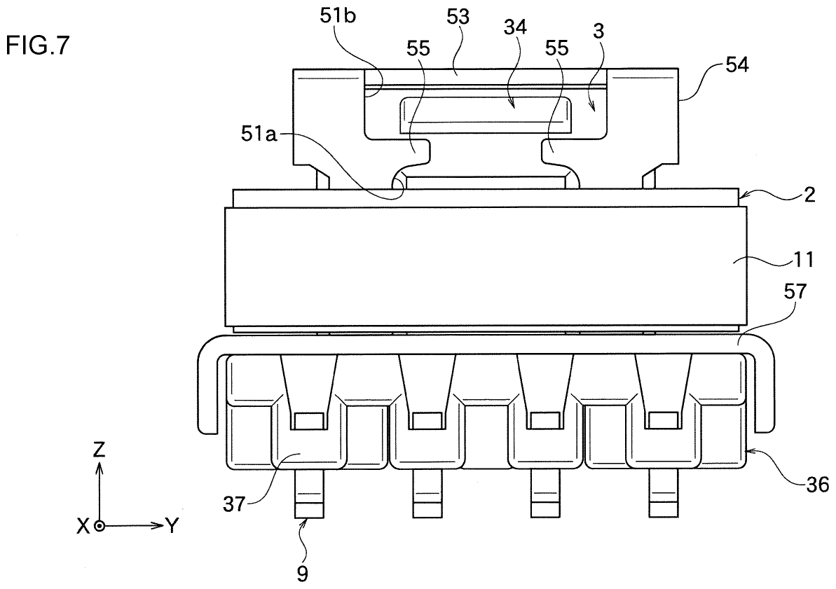

FIG. 8 is a bottom view showing a configuration of the coil part of the coil device shown in FIG. 1.

FIG. 9 is a plan view showing a configuration of the coil part of the coil device shown in FIG. 1.

FIG. 10 is a perspective diagram of a coil device according to another embodiment.

FIG. 11 is a plan view of the coil device shown in FIG. 10.

FIG. 12 is a perspective diagram of the coil device according to further another embodiment.

FIG. 13 is a perspective diagram showing a configuration of a bobbin of the coil device shown in FIG. 12.

FIG. 14 is a perspective diagram showing a configuration of a cover of the coil device shown in FIG. 12.

FIG. 15 is a perspective diagram showing a configuration of a core of the coil device shown in FIG. 12.

FIG. 16 is a plan view of the coil device shown in FIG. 12.

### DETAILED DESCRIPTION

One aspect of an embodiment of the present disclosure is described using the figures. The embodiment of the present disclosure is explained by referring to the figures depending on needs; however, the contents of the figures are schematic and exemplary representation. Thus, the sizes, the appearances, and so on shown in the figures may not accurately represent the actual sizes, appearances, and so on of the coil device of the present disclosure. Hereinafter, the present disclosure is described in detail using the embodiments, however, the present disclosure is not to be limited thereto.

### First Embodiment

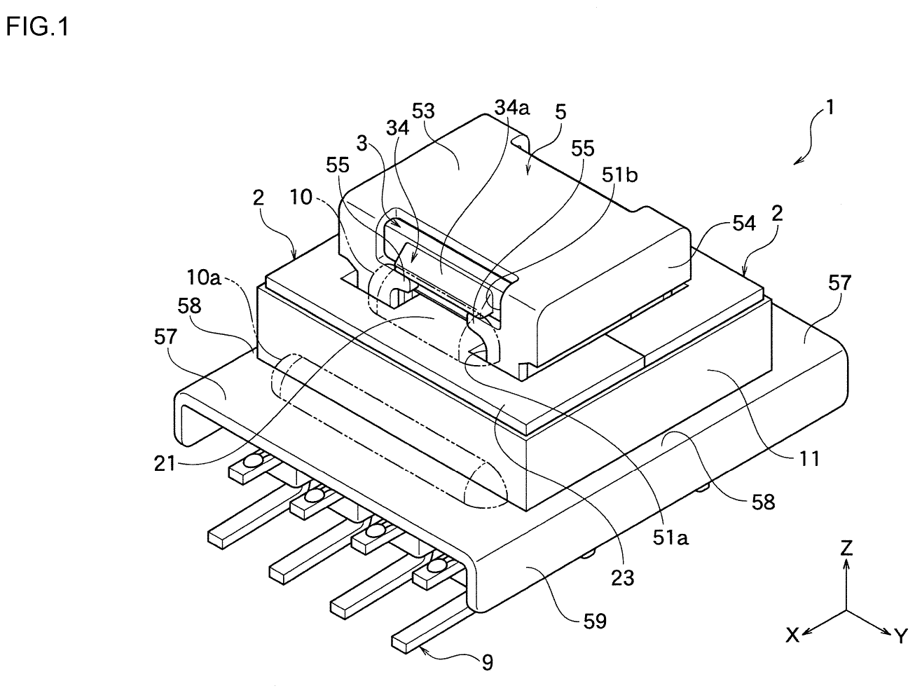

As shown in FIG. 1, for example, the coil device 1 according to the present embodiment may be used as an on-board charger for Electric Vehicle (EV), Plug-in Hybrid Vehicle (PHV), commuter (vehicle), or so; it may also be used as a power circuit for house hold or industrial electronic device. Further, it may also be used as a power circuit for computer device, or may be as a transformer to which high voltage is applied.

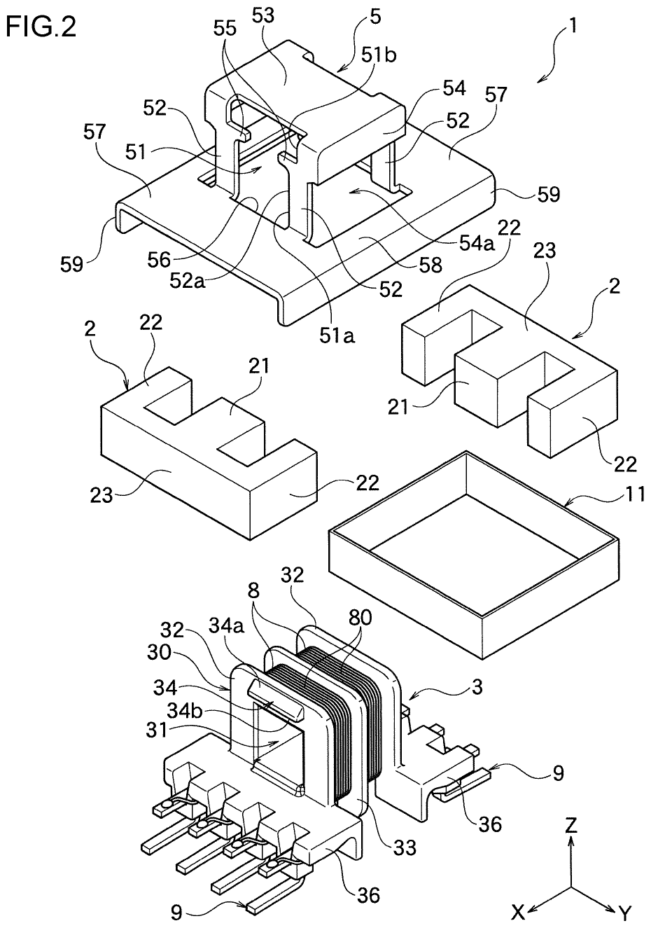

As shown in FIG. 1 and FIG. 2, this coil device 1 includes a core (magnetic core) 2, a bobbin 3, and a cover 5. Note that, in the figures, X-axis, Y-axis, and Z-axis are perpendicular to each other, and Z-axis corresponds to a height (thickness) of the coil device 1. Also, X-axis is parallel to a winding axis of the coil part which is described in below.

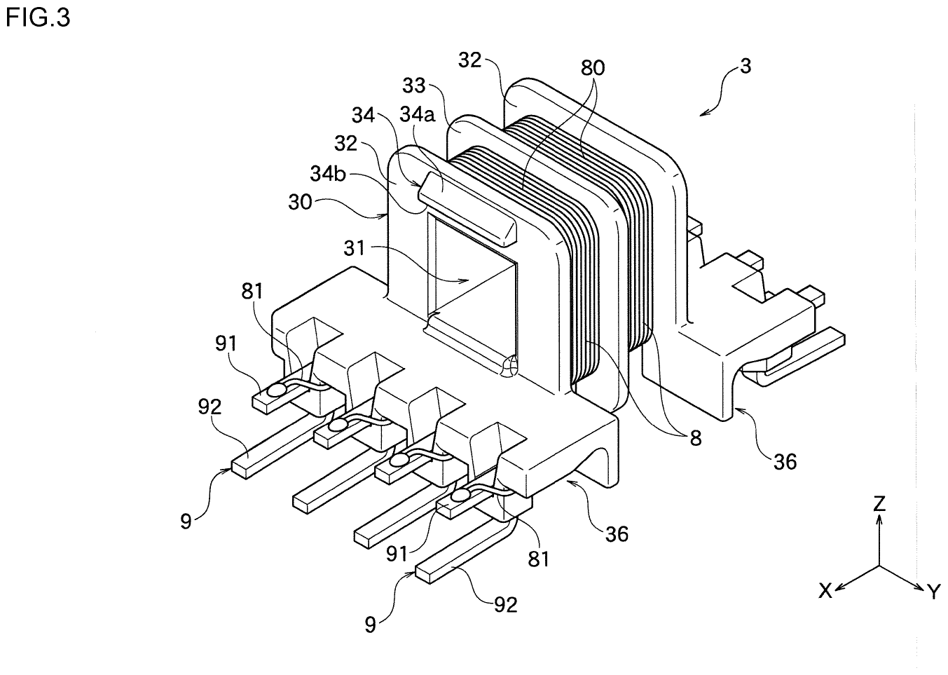

As shown in FIG. 2 and FIG. 3, the bobbin 3 includes a tubular part 30, and a pair of terminal blocks 36 and 36 formed integral with the tubular part 30 in a way that each of the terminal blocks 36 and 36 are positioned opposite of each other in X-axis direction of the tubular part 30.

Note that, in the present embodiment, the pair of terminal blocks 36 and 36 has the same configurations, however, the shape of each of these does not necessarily have to be the same. For example, the number of terminals 9 installed on one terminal block 36 and the number of terminals 9 installed on the other terminal block 36 may be different. Also, for example, the shape of terminals 9 installed on one terminal block 36 and the shapes of terminals 9 installed on the other terminal block 36 may be different, and also the shapes of terminal blocks may be different.

The tubular part 30 of the bobbin 3 includes a winding core part where the wire is wound around, and a first end flange 32 and a second end flange 32 which are positioned on both sides in X-axis direction of the winding core part. Also, at the outer circumference of the winding core part of the tubular part 30 positioned between the first end flange 32 and the second end flange 32, the middle flange 33 is integrally formed. At the tubular part 30, a core leg through hole 31 penetrating through in X-axis direction of the winding core part on which the first end flange 32, the middle flange 33, and the second end flange 32 are formed.

In the present embodiment, the cores 2 and 2 have the same shapes, and the cross-section shapes along X-Y plane are E-shape, which are a so-called E-shape core. That is, each of cores 2 and 2 respectively has a base part 23 extending in Y-axis direction, a pair of outer leg parts 22 and 22 protruding out along X-axis from both ends in Y-axis direction of the base part 23, and a middle leg part 21 protruding out along X-axis from a center area in Y-axis direction between the outer leg parts 22 and 22.

In the present embodiment, the middle leg parts 21 and 21 are made so that these can be inserted from both ends in X-axis direction into the core leg through hole of the bobbin 3. At the inside of the core leg through hole 31, the tips of the middle leg parts 21 and 21 may face and contact each other, or may face each other while taking a predetermined gap in between. Note that, by forming such gap, a leakage characteristic can be adjusted depending on a width of the gap.

As shown in FIG. 2, each of the middle leg parts 21 and 21 has a square prism shape so as to match with an inner circumference shape of the core leg through hole 31. However, the shapes of the middle leg parts are not limited to this, and it may vary in accordance with the shape of the core leg through hole 31. Also, each of the outer leg parts 22 and 22 has a shape which matches with a end face shape in Y-axis direction of the flanges 32 and 33; and an outer surface of the outer leg part 22 includes a plane which is parallel to XZ plane (a plane including X-axis and Z-axis). In the present embodiment, the material of the cores 2 and 2 may be metals, a soft magnetic material such as ferrite, however, it is not limited thereto.

The terminal blocks 36 and 36 respectively extends to outside along X-axis from the lower side in Z-axis direction of the end flanges 32 and 32 (that is, it extends along X-axis away from the center of the bobbin 3. The same applies hereinbelow). Preferably, the upper face in Z-axis direction of the terminal block 36 is lower than a bottom face of the through hole 31 by a length equivalent to a thickness of the terminal block cover part 57 of the cover 5 which is described in below. Preferably, the upper face of the terminal block cover part 57 and the bottom face of the through hole 31 are configured to have no difference in height between each other. By having such configuration, the middle leg part 21 of the core 2 can smoothly move to the bottom face of the through hole 31 from the upper face of the terminal block cover part 57.

Also, the widths of the terminal blocks 36 and 36 in Y-axis direction are wider than the Y-axis direction widths of the end flanges 32 and 32, and the terminal blocks 36 and 36 protrude out by predetermined widths from the both end faces of the flanges 32 in Y-axis direction. The predetermined widths of protrusion of the terminal blocks 36 and 36 along Y-axis from the both end faces of the flanges 32 and 32 in Y-axis direction is preferably about the same as the Y-axis direction width of the outer leg parts 22 of the core 2. The upper faces of the terminal blocks 36 and 36 are covered with the terminal block cover parts 57 and 57 of the cover 5, and the cores 2 and 2 are arranged thereon.

For each terminal block 36, a plurality of terminals 9 is aligned and embedded along Y-axis. As shown in FIG. 3, each terminal 9 has a wire connecting part 91 and a mounting part 92, and the terminal 9 is insert molded to the terminal block 36 of the bobbin 3 so that the space between the wire connecting part 91 and the mounting part 92 is embedded in the terminal block 36.

One lead part 81 from a plurality of wires 8 is connected to the wire connecting part 91. The mounting part 92 is a part which connects to a circuit pattern such as a circuit board not shown in the figure, and through each terminal 9, a coil part 80 which is formed by the wires 8 is connected to the outside circuit such as a circuit board.

As shown in FIG. 3, in the present embodiment, the wires 8 are wound around the outer circumference of the winding core part which is positioned between the first flange 32 and the middle flange 33, and also positioned between the middle flange 33 and the second flange 32; thereby a single transformer or a plurality of transformers is configured by the coil part 80 and the coil part 80.

The wire 8 may be made of a single wire, or may be made of a stranded wire such as a Litz wire. A wire diameter of the wire 8 is not particularly limited, and preferably, it is within a range of 0.1 to 0.4 mm. The wire 8 may be configured by a conductive wire such as a metal wire, or it may also be an insulation coated wire.

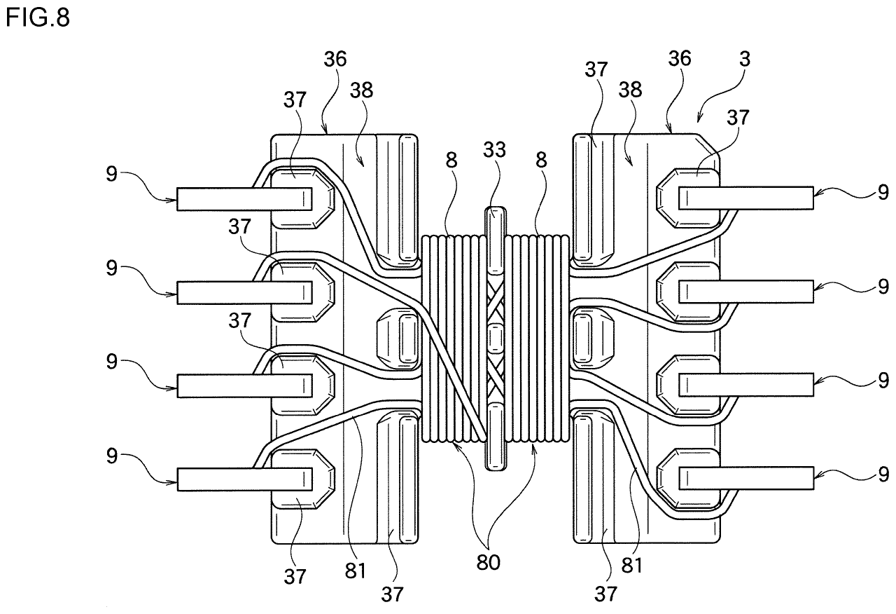

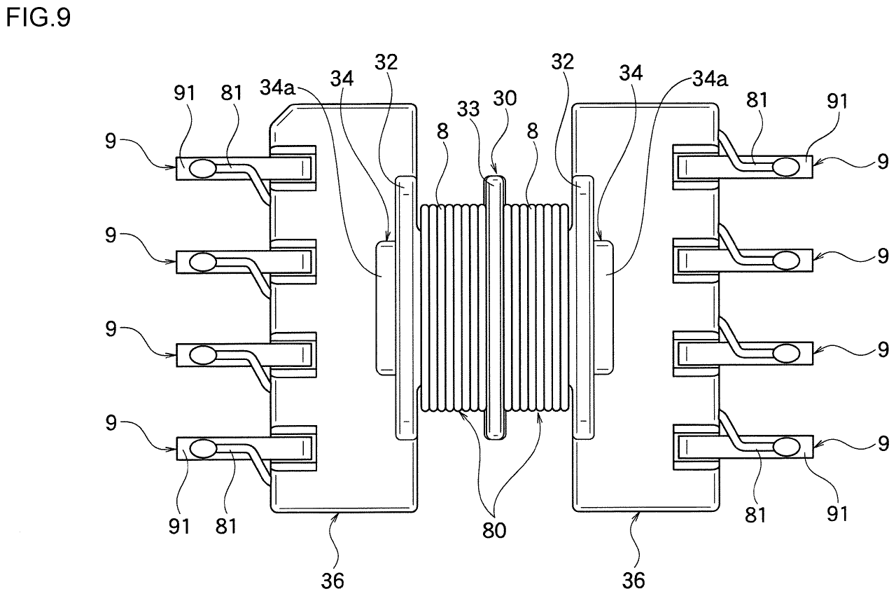

As shown in FIG. 8, a pair of lead parts 81 and 81 which is both ends of one wire 8 configuring the coil part 80 passes through lead passages 38 formed between reinforcement ribs 37 at the bottom face of the terminal block 36 to guide lead part 81 towards each terminal 9; and as shown in FIG. 9, the lead parts 81 and 81 are respectively connected to the wire connecting parts 91 of the terminals 9.

The bobbin 3 including the tubular part 30 and the terminal blocks 36 are made integrally, for example, by using plastic such as PPS, PET, PBT, LCP, nylon, and so on, however, it may be made of other insulation material. Note that, in the present embodiment, as the bobbin 3, preferably it is made of plastic with high thermal conductivity of 1 W/m K or higher, and for example, it may be made of PPS, nylon, and so on.

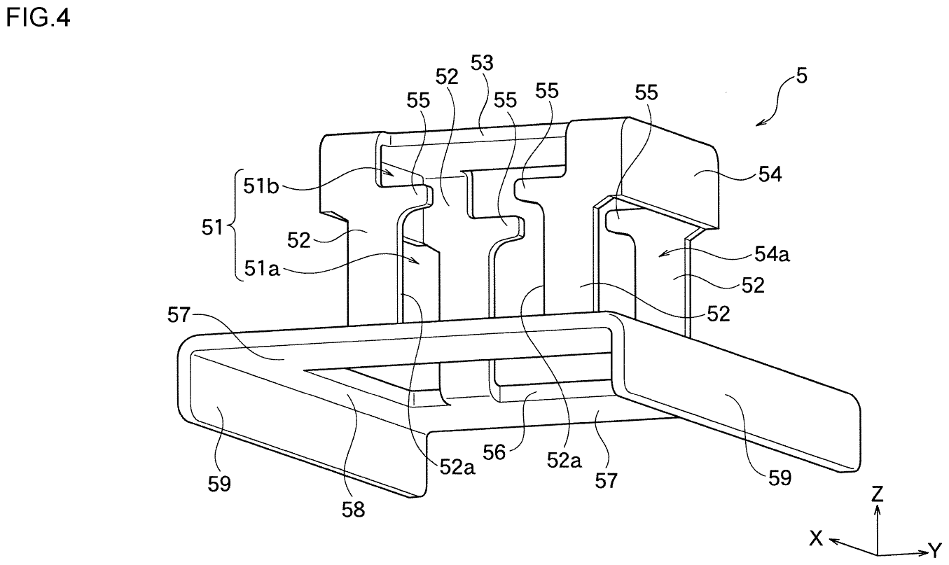

As shown in FIG. 2 and FIG. 4, the cover 5 is made of separate member from the bobbin 3. This cover 5 can be made of the same insulation material as the bobbin 3, however, it is preferably made of an insulation material having a higher resilience than the bobbin 3. For example, preferably it may be made of LCP, nylon, or so.

The cover 5 includes the terminal block cover parts 57 and 57 respectively covering the upper face in the Z-axis direction of the pair of the terminal blocks 36 and 36, and connecting cover parts 58 and 58 extending along X-axis direction so as to connect the both ends in Y-axis direction of the terminal block cover parts 57 and 57. The upper faces of the terminal block cover parts 57 and 57 and the connecting cover parts 58 and 58 are one continuous surface, and the base parts 23 and 23 and the outer leg parts 22 and 22 of the cores 2 and 2 are arranged thereon. At both ends in Y-axis direction of the terminal block cover parts 57 and 57 and the connecting cover parts 58 and 58, side end cover parts 59 are integrally formed which covers the upper parts of the both end faces along Y-axis of the terminal blocks 36 and 36.

At the center part of the cover 5 which is surrounded by the terminal block cover parts 57 and 57 and the connecting cover parts 58 and 58, a center opening 56 is formed; and the upper part of the tubular part 30 of the bobbin 3 can be inserted into the center opening 56 from the lower side in Z-axis direction.

At each of opening edges of both ends along X-axis of the center opening 56 of the cover 5, end walls 52 are formed in a way that it stands upwards in Z-axis direction. At the center part in Y-axis direction of each end wall 52, an end wall opening 51 is formed which intersects and communicates with the center opening 56. The cover 5 includes an upper wall 53 so that the upper end of each of the end walls 52 positioned at both ends along X-axis is connected by the upper wall 53.

Also, the cover 5 includes side walls 54 and 54 which are integrally formed so as to connect the upper parts of both ends along Y-axis direction of the end walls 52 positioned at both sides in X-axis. A lower side along Z-axis of each side wall 54 is cutout so that each of the side walls 54 and 54 do not directly contact with the connecting cover part 58; and the side walls 54 and 54 of the cover 5 include side openings 54a which connect with the center opening 56.

As shown in FIG. 4, each end opening 51 is separated into a main opening 51a and a sub-opening 51b by having the claw-like parts 55 in between and projecting into the end wall opening 51 from the opening edges 52a positioned at both sides along Y-axis of the end wall opening 51; and the main opening 51a and the sub-opening 51b are continuous with each other. A width of the main opening 51a along Y-axis is narrower than a width of the sub-opening 51b along Y-axis; and a width in Y-axis direction between the claw-like parts 55 and 55 which are positioned on both sides of the end wall opening along Y-axis is narrower than a width of the main opening 51a in Y-axis direction. By making the width in Y-axis direction of the sub-opening 51b wider than the width in Y-axis of the main opening 51a, the claw-like parts 55 can easily deform resiliently, and also the adhesive 10 easily enters inside the sub-opening 51b. The upper end of the sub-opening 51b extends in a way that part of the upper wall 53 is cutout part of the upper wall 53 from the intersection part of the end wall 52 and the upper wall 53.

As shown in FIG. 2 and FIG. 3, at upper side in Z-axis of the end face along X-axis of the end flange 32 of the bobbin 3, a raised part 34 as the second engagement part is integrally formed at the positioned above the through hole 31. The raised part 34 is formed so that it projects out along X-axis from the end face in X-axis of the end flange 32. A length of the raised part 34 in Y-axis is shorter than the width in Y-axis between the claw-like parts 55 and 55 positioned on both sides in Y-axis of the end wall opening 51, or may be the same length of the main opening 51 along Y-axis, or may be slightly longer than this. This is because the raised part 34 enters inside the main opening 51a, and the slanted face 34a of the raised part 34 contacts with the claw-like parts 55 and 55.

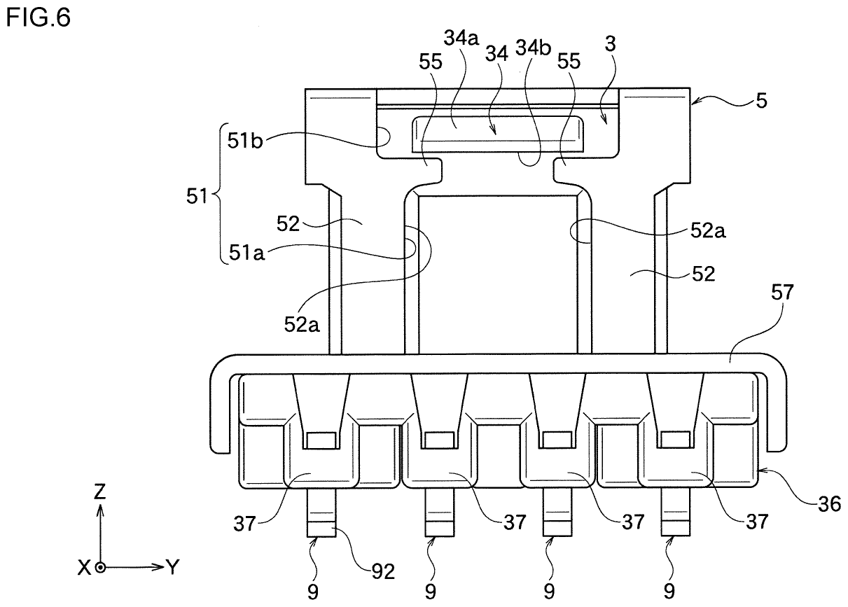

As shown in FIG. 3, the raised part 34 includes a slanted face 34a which resiliently deforms the claw-like parts 55 as the first engagement part shown in FIG. 2 along X-axis and guides the claw-like parts 55 along the slanted face towards a hook part 34b, and the hook part 34b where the claw-like parts 55 are latched. The hook part 34b is formed at lower side in Z-axis direction of the slanted face 34a, and it forms a lower face of the raised part 34. The slanted face 34a forms the upper face of the raised part 34. As shown in FIG. 6, the claw-like parts 55 and 55 are formed at the opening edge 52a of the end wall 52 so that the claw-like parts 55 and 55 latch to the hook part 34b from the both sides along Y-axis.

The width between the end wall 52 and the end wall 52 shown in FIG. 4 which are facing each other in X-axis direction is about the same as or slightly wider than the width between the end face of the end flange 32 and the end face of the end flange 32 of the bobbin 3 shown in FIG. 3 which are facing each other. Also, a height of projection of the raised part 34 formed to the end face of the end flange 32 is designed such that the raised part 34 projects out in X-axis direction from the sub-opening 51b of the cover 5 once the cover 5 is installed on the bobbin 3 as shown in FIG. 1.

Therefore, when the cover 5 is placed over the bobbin 3 from the above along Z-axis, the claw-like parts 55 contact the slanted face 34a of the raised part 34, and the claw-like parts 55 resiliently deform in X-axis direction and moves along the slanted face and are guided to the hook part 34b. Once the claw-like parts 55 pass through the position where the raised part 34 is most protruded outward, the shapes of the claw-like parts 55 return to the original shapes, the claw-like parts 55 automatically latch to the raised part 34b from both sides along Y-axis.

Next, an example of a production method of the coil device 1 according to the present embodiment is described. As shown in FIG. 3, the coil device 1 is produced by winding the wires 8 around the winding core part of the bobbin 3, and then by assembling the members shown in FIG. 2.

First, the bobbin 3 shown in FIG. 3, FIG. 8, and FIG. 9 is prepared, and the wires 8 are wound around the winding core part of the tubular part 30 of the bobbin 3 to form the coil part 80, and the lead parts 81, which are both ends of the wire 8, are connected to the wire connecting parts 91 of the terminals 9. As a method for connecting the lead parts 81 to the wire connecting parts 91 of the terminals 9, it is not particularly limited, and for example, caulking, thermal compression bonding, laser welding, soldering, and so on may be mentioned.

Next, the cover 5 shown in FIG. 4 is installed on the bobbin 3 shown in FIG. 3 from the above. When installing the cover 5 on the bobbin 3, the cover 5 and the bobbin 3 are assembled such that the upper part of the tubular part 30 of the bobbin 3 shown in FIG. 2 is inserted to the center opening 56 of the cover 5. When the cover 5 and the bobbin 3 are assembled, the raised part 34 of the bobbin 3 passes through the main opening 51a of the end wall opening 51 from the center opening 56, and the claw-like parts 55 contact the slanted face 34a of the raised part 34. Then, the claw-like parts 55 resiliently deform outward along X-axis and moves along the slanted face 34a, and the claw-like parts 55 latch to the hook part 34b of the raised part 34.

As a result, the position of the main opening 51a of the end opening 51 formed on the cover 5 and the position of the through hole 31 of the bobbin 3 will be self-aligned. From the sub-opening 51b, the raised part 34 of the bobbin 3 is exposed out of the cover 5. Note that, the claw-like parts 55 are shaped so that the claw-like parts 55 do not enter the through hole 31 of the bobbin 3.

Next, while the cover 5 is installed on the bobbin 3, the cores 2 and 2 are installed to the cover 5 from the both sides along X-axis. That is, the middle leg parts 21 and 21 are inserted into the through hole 31 of the bobbin 3 from the main opening 51a of the cover 5, and the cores 2 and 2 are installed in the cover 5 so that the outer leg parts 22 and 22 of the cores 2 and 2 are provided on the upper surface of the connecting cover part 58 of the cover 5.

A gap may be formed between the tips of the middle leg parts 21 and 21 which have been inserted in the through hole 31. Alternatively, no gap may be formed between the tips. Also, the tips between the outer leg parts 22 are preferably in contact with each other.

Next, a tape 11 is placed around the cores 2 and 2 installed in the cover 5, thereby, the cores 2 and 2 may be strongly fixed to the cover 5 and the bobbin 3. Note that, the tape 11 is preferably an insulation tape, and for example, it is a plastic or rubber tape.

Next, as shown in FIG. 1, the adhesive 10 is applied so that the adhesive 10 covers at least part of the raised part 34 of the bobbin 3 projecting out from the sub opening 51b of the cover 5, at least part of the claw-like parts 55 of the cover 5, and at least a part of the core 2 (preferably, a part of a boundary between the middle leg part and the base part 23).

Preferably, the part where the claw-like parts 55 of the cover 5 and the raised part 34 are closest to each other is included in a fixing area by the adhesive 10. Also, the boundary area between the main opening 51a and the sub-opening 51b is also preferably included in the fixing area by the adhesive 10. The adhesive 10 is not particularly limited, and for example, it may be an epoxy-based adhesive, a silicone-based adhesive, and so on.

In the present embodiment, for example, as shown in FIG. 1, a sufficient space is formed between the lower part of the raised part 34 projecting out from the sub-opening 51b and the upper surface of the core 2, and also a sufficient space is formed between the claw-like parts 55 and 55; thus, even if the adhesive 10 has a low fluidity, the adhesive 10 can easily enter into these spaces. Also, the adhesive 10 can easily enter into the sub-opening 51b positioned around the raised part 34. Thus, the adhesive strength between the core 2, the bobbin 3, and the cover 5 by the adhesive 10 is improved, and the strength against vibration load applied to the coil device 10 can be improved. Also, in the present embodiment, since the strength is improved, the cover 5 can be thinned.

Note that, an adhesive 10a which may be the same as or different from the adhesive 10 is adhered on the interception part of the upper surface of the terminal block cover part 57 and the tape 11 to fix these. Note that, in the case that the tape 11 is not used, the adhesive 10a is used to adhere and fix the base part 23 of the core 2 and the terminal block cover part 57 of the cover 5.

In the coil device 1 according to the present embodiment, when the cover 5 is installed on the bobbin 3, the claw-like parts 55 which are the first engagement part of the cover 5 engage with the raised part 34 of the bobbin 3. Therefore, for example, even in the case of transporting the bobbin 3 to which the cover 5 while holding the upper face of the upper wall 53 of the cover 5, it becomes difficult for the cover 5 to be released from the bobbin 3, thus, the assembling property improves.

Also, when the cover 5 is installed to the bobbin 3, the position of the end wall opening 51 of the cover 5 and the through hole 31 of the bobbin 3 are automatically arranged, and it becomes easy to install the core 2 in the end wall opening 51 and the through hole 31, hence, from this perspective also, the assembling property improves. Also, the cover 5 is fit and fixed on the bobbin 3 by the claw-like parts 55, and for example, the core 2, the bobbin 3, and also the claw-like parts 55 are adhered by the adhesive 10. Thereby, the adhesive strength between the cover 5, the bobbin 3, and the core 2 are improved, and the strength reliability of the coil device 1 is improved.

Also, the tubular part 30 of the bobbin 3 has the end flanges 32 and 32 at the end along X-axis; and the end flanges 32 and 32 respectively has the raised parts 34 as the second engagement part which engages with the claw-like parts 55 and 55 of the cover 5. By configuring as such, the assembling property is further improved, and the strength reliability of the coil device 1 is further improved.

Also, the raised part 34 includes the slanted face 34a which deforms the claw-like part 55 and guides the claw-like part 55 along the slanted face 34a, and the hook part 34b where the claw-like part 55 latches. When the cover 5 is being installed on the bobbin 3, the claw-like part 55 of the cover 5 resiliently deforms and moves along the slanted face 34a of the raised part 34, then, it returns to its original shape, thereby, the claw-like part 55 automatically latches to the hook part 34b. Hence, the cover 5 fits to the bobbin 3 in a one-touch manner. Therefore, the assembling property further improves, and the strength reliability of the coil device 1 further improves.

Further, in the preset embodiment, the claw-like part 55 is arranged on the end wall 52 where the end opening 51 is formed. By configuring as such, the claw-like part 55 deforms resiliently, and the cover 5 can easily fit to the bobbin 3 in a one-touch manner. Therefore, the assembling property further improves, and the strength reliability of the coil device 1 further improves.

Also, in the present embodiment, the claw-like part 55 projects into the end opening 51 from the opening edge 52a of the end wall 52, and the claw-like part 55 is provided on the both sides in a width direction of the through hole 31. By configuring as such, the first engagement part made of the pair of claw-like parts 55 easily deforms resiliently, and the cover 5 can easily fit to the bobbin 3 in a one-touch manner.

Note that, for other embodiments, a single claw-like part 55 may be formed to one end opening 51, and the other single claw-like part 55 may be formed to another end opening 51 facing each other in X-axis direction. In such case, the single claw-like part 55 formed to one end opening 51, and the other single claw-like part 55 formed to another end opening 51 facing each other in X-axis direction are preferably arranged at the position which are diagonal to each other when viewed from Z-axis direction.

In the present embodiment, the claw-like parts 55 and 55 separate the end opening 51 into the main opening 51a and the sub-opening 51b, and it is configured so that the middle leg part 21 can be inserted into the main opening 51a. By configuring as such, the position of the main opening 51a of the cover 5 and the through hole 31 of the bobbin 3 can be aligned even more securely, and the middle leg part 21 of the core 2 can be easily inserted into the through hole 31 and the main opening 51a.

Further, in the present embodiment, the bobbin 3 includes the terminal block 36 installed on the terminal 9 where the lead part 81 pulled out from the coil part 80 of the wire 8 is connected, and the cover 5 includes the terminal block cover part 57 covering the terminal block 36. Due to the terminal cover part 57 of the cover 5, the insulation distance between the terminal 9 and the core 2 becomes longer, and the insulation resistance improves.

### Second Embodiment

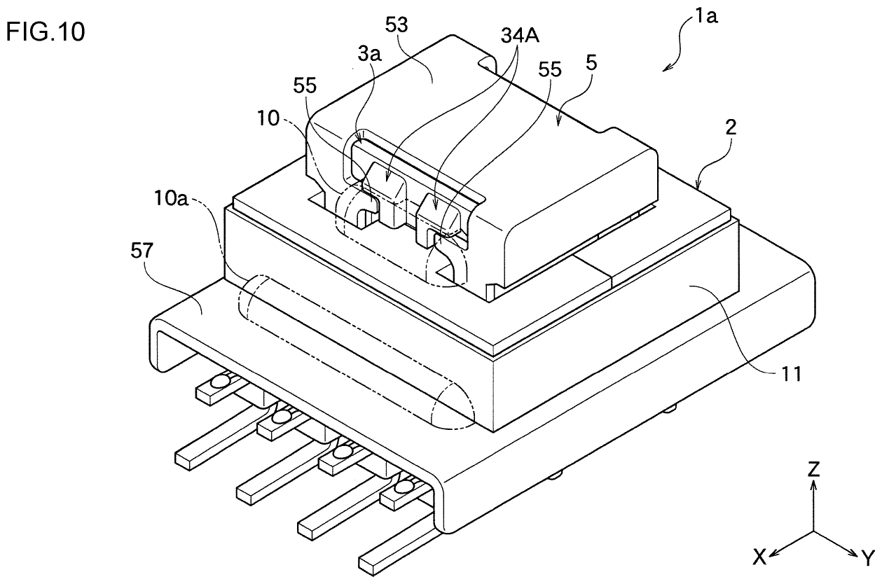

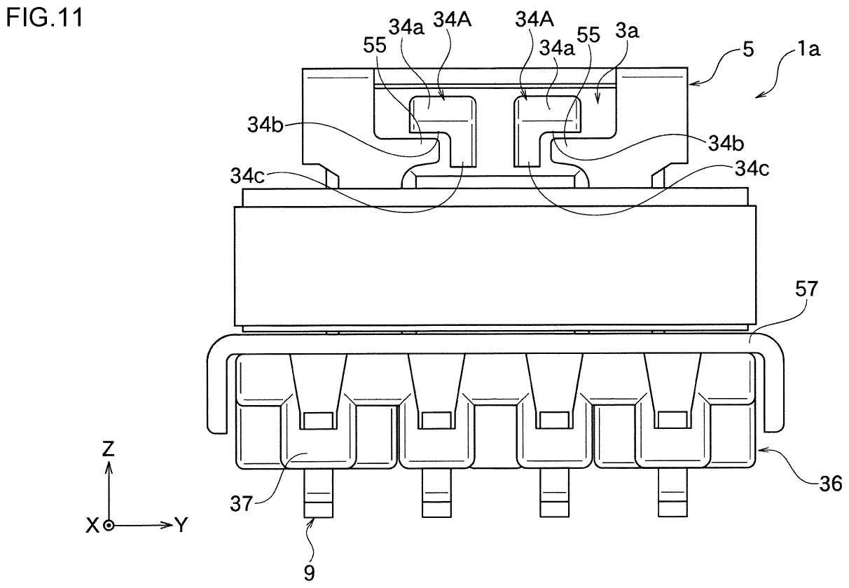

A coil device 1a according to the present embodiment shown in FIG. 10 and FIG. 11 is different from the coil device 1 of the aforementioned first embodiment in parts shown in below; and the parts which are the same as the first embodiment are omitted form explaining.

In the below embodiment, a bobbin 3a has raised parts 34A as the second engagement part which is different from that of the first embodiment. As shown in FIG. 10 and FIG. 11, in the present embodiment, the raised parts 34A formed on at least one of the end flanges 32 of the bobbin 3a are separated along Y-axis, and when viewed from X-axis direction, the raised parts 34A respectively has an inverted L-shape. The raised parts 34 respectively has a slanted face 34a and a hook part 34b.

At inside in Y-axis direction, each raised part 34A is integrally formed with a stopper 34c which extends downward along Z-axis. Note that, the stoppers 34c and 34c are separated along Y-axis when viewed from X-axis direction, however, it may be a single continuous stopper 34c. That is, the raised parts 34A separated along Y-axis may be continuous.

As each raised part 34A has the stopper 34c, a relative movement of the raised part 34A and the claw-like part 55 in Y-axis direction is limited, and this prevents the bobbin 3a and the cover 5 from shifting the position in Y-axis direction.

Note that, the positions of the cover 5 and the bobbin 3a (also the bobbin 3) along Z-axis direction are aligned, for example, by contacting the inner face of the terminal block coating part 57 of the cover 5 with the upper face of the terminal block 36 of the bobbin 3 (see FIG. 3), which is the same case for the aforementioned first embodiment. Alternatively, the positions of the cover 5 and the bobbin 3a (also the bobbin 3) along Z-axis may be aligned, for example, by contacting the inner face of the upper wall 53 of the cover 5 with the upper face of the flanges 32 and 33 of the bobbin 3 (see FIG. 3).

Also, for example, the positions of the cover 5 and the bobbin 3a (also the bobbin 3) along X-axis are aligned by contacting the inner face of the end wall 52 of the cover 5 with the end face of the end flange 32 of the bobbin 3 (see FIG. 3). Alternatively, the positions of the cover 5 and the bobbin 3a (also the bobbin 3) may be aligned by contacting the inner face of the claw-like part 55 of the cover 5 with the end face of the end flange 32 of the bobbin 3 (see FIG. 3). As similar to the first embodiment, in the second embodiment, the claw-like parts 55 may be bent slightly inwards along X-axis than the end wall 52 so that the claw-like parts 55 can easily contact the end face of the end flanges 32 of the bobbin 3 (see FIG. 3).

### Third Embodiment

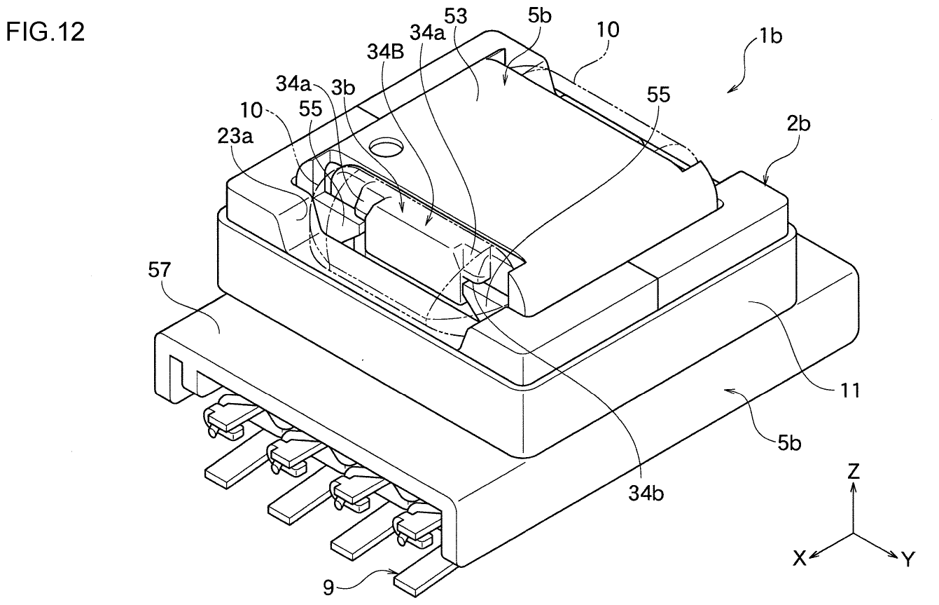

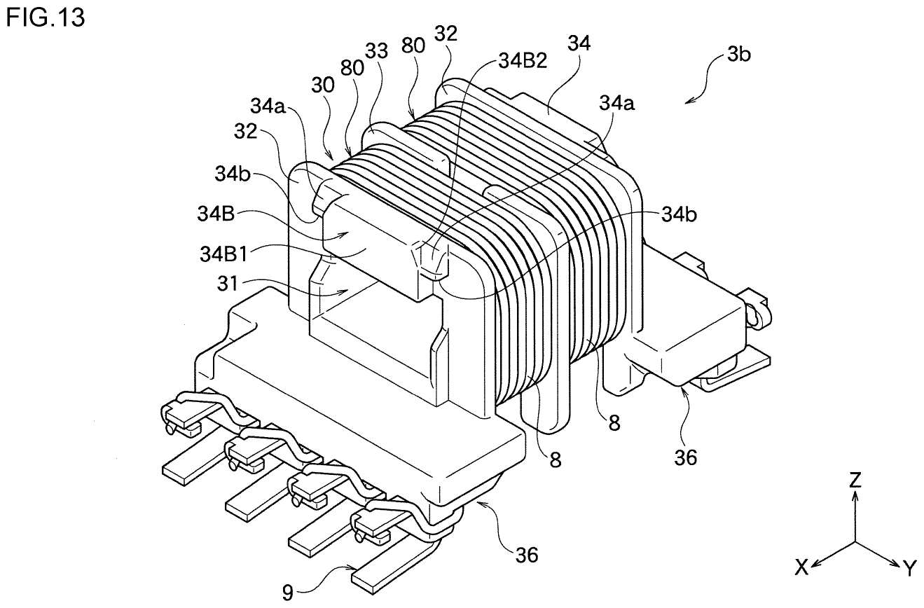

A coil device 1b according to the present embodiment shown in FIG. 12 to FIG. 16 are different from the coil device 1 of the first embodiment and the coil device 1a of the second embodiment in parts shown in below, and the parts which are common with the first embodiment and the second embodiment are omitted.

For the coil device 1b according to the present embodiment, a bobbin 3b, a cover 5b, and a core 2b have different configurations from those of the first and second embodiments.

As shown in FIG. 12 to FIG. 16, in the present embodiment, raised parts 34B formed on at least one of the end flanges 32 of the bobbin 3b has a raised part block 34B1 at the center, and a slanted face 34a and a hook part 34b are respectively formed to both sides of the raised part block 34B1 along Y-axis. Also, at upper part of both sides along Y-axis of the raised part block 34B1, a slanted support face 34B2 is respectively formed.

An inner tip of the claw-like part 55 of the cover 5b can contact the slanted support face 34B2 (the inner tip does not necessarily have on contact the slanted support face 34B2). When the cover 5b is installed on the bobbin 3b, in the case that the inner tip of the claw-like part 55 of the cover 5b contacts the slanted support face 34B2, the relative position of the cover 5b against the bobbin 3b can be self-aligned.

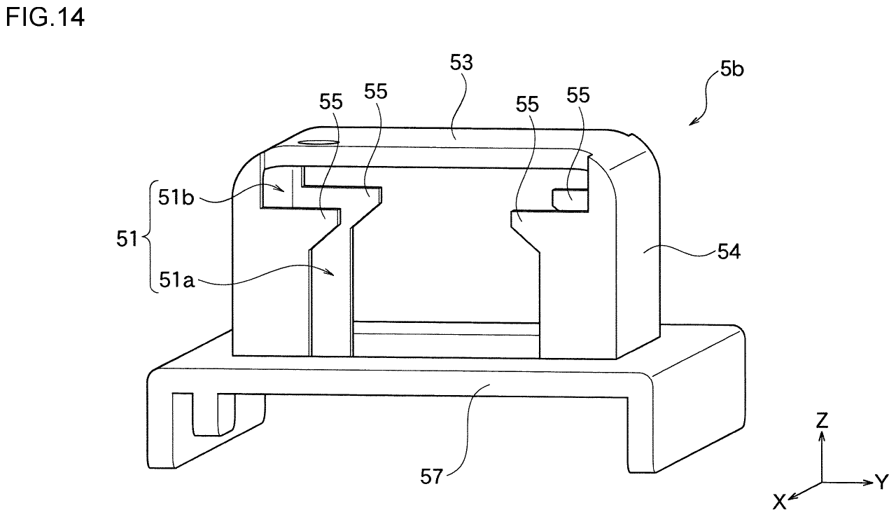

Also, in the present embodiment, as shown in FIG. 14, the side opening 54a is not formed on the side wall 54 of the cover 5b which is different from the first and second embodiments. Also, the shape of the claw-like part 55 is not necessarily the same as the first and second embodiments, however, the shape based on the basic function is the same.

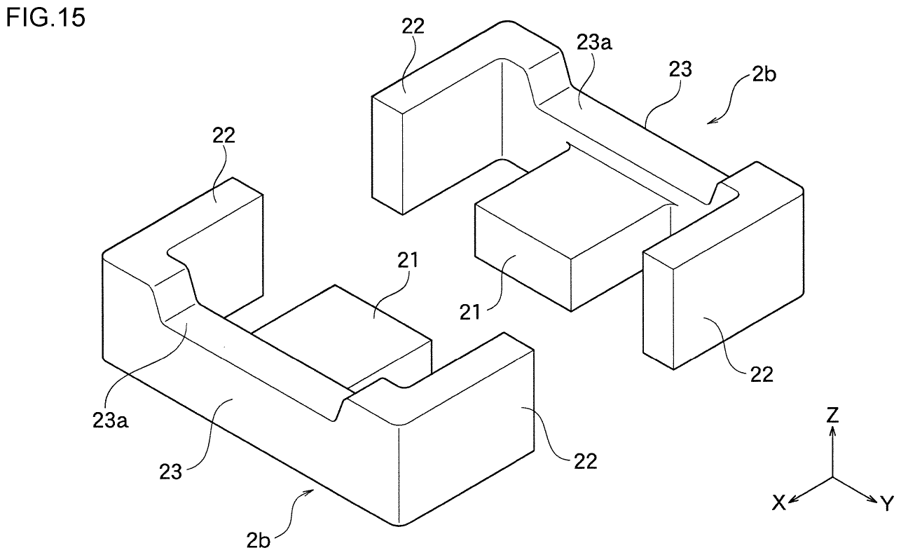

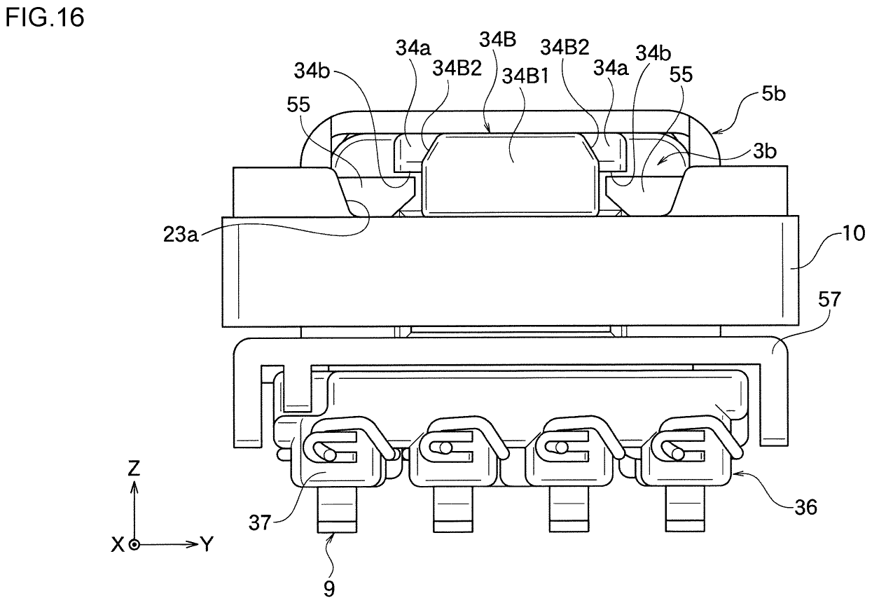

Further, in the present embodiment, as shown in FIG. 15, each core 2b has a dented part 23a dented downward along Z-axis at a center part of the base part 23, which is different from the configuration of the core 2 of the first and second embodiments. As shown in FIG. 12 and FIG. 16, the dented part 23a also function as a part to store the adhesive 10, and thus, this enhances the adhesive strength between the claw-like parts 55 of the cover 5, the core 2, and the bobbin 3 using the adhesive 10. Also, in the present embodiment, as shown in FIG. 12, a tape 11 and the cover 5b may not be fixed using the adhesive.

The coil device 1b of the present embodiment also exhibit the same effects as the coil device 1 of the first embodiment and the coil device 1a of the second embodiment.

Note that, the present disclosure is not limited to the above-mentioned embodiments, and various modifications are possible within the scope of the present disclosure.

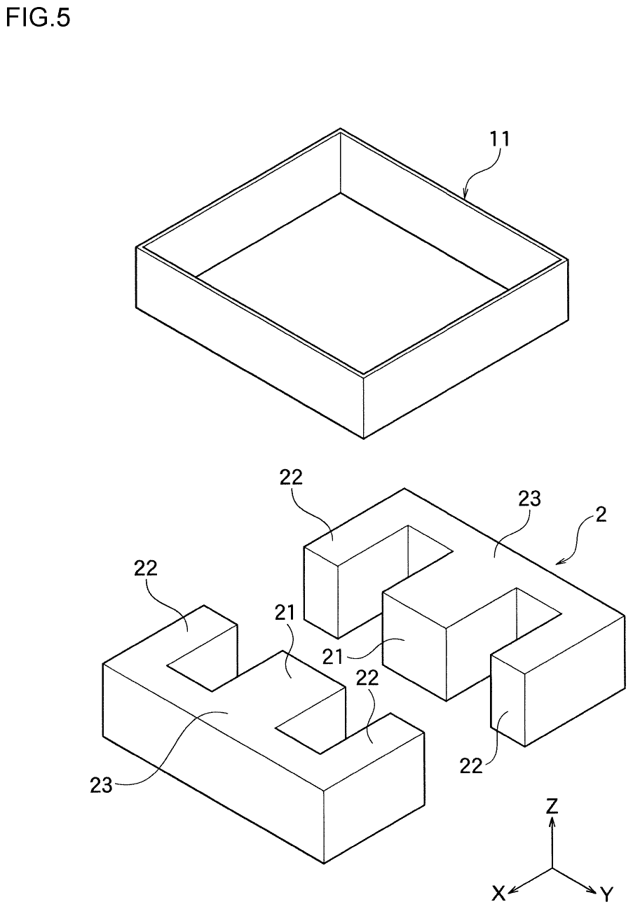

For example, in the above-mentioned embodiments, as shown FIG. 5, the core was configured by combining the E-shape cores 2 and 2, however, the cores with different shapes may be combined. That is, either one may be E-shape core, and the other may be I-shape core. Also, the cores 2 and 2 may be respectively divided into a plurality of parts.

### REFERENCE SIGNS LISTS

1,1a,1b . . . Coil device
2,2b . . . Core
21 . . . Middle leg part
22 . . . Outer leg part
23 . . . Base part
23a . . . Dented part
3,3a,3b . . . Bobbin
30 . . . Tubular part
31 . . . Through hole
32 . . . End flange
33 . . . Middle flange
34,34A . . . Raised part (Second engagement part)
34a . . . Slanted face
34b . . . Hook part
34c . . . Stopper
36 . . . Terminal block
37.. Reinforcement ribs
38 . . . Lead passage
5,5b . . . Cover
51 . . . End wall opening
51a . . . Main opening
51b . . . Sub-opening
52 . . . End wall
52a . . . Opening edges
53 . . . Upper wall
54 . . . Side wall
54a . . . Side opening
55 . . . Claw-like part (First engagement part)
56 . . . Center opening
57 . . . Terminal block covering part
58 . . . Connecting cover part
59 . . . Side end cover part
8 . . . Wire
80 . . . Coil part
81 . . . Lead part
9 . . . Terminal
91 . . . Wire connecting part
92 . . . Mounting part
10,10a . . . Adhesive
11 . . . Tape

What is claimed is:

1. A coil device, comprising:
a bobbin including a tubular part;
a wire wound around the tubular part;
a cover capable of being installed on the bobbin; and
a core including a middle leg part, wherein
the cover comprises an end wall having an end wall opening arranged at an end part of the tubular part so as to connect with a through hole of the tubular part, and a first engagement part engaging with the bobbin; and
the middle leg part is arranged so as to be inserted into the end wall opening and the through hole.

2. The coil device according to claim 1, wherein
the tubular part comprises a flange at the end part, and
the flange comprises a second engagement part engaging with the first engagement part.

3. The coil device according to claim 2, wherein the second engagement part comprises a raised part projecting from an end face of the flange.

4. The coil device according to claim 3, wherein
the raised part comprises a slanted face which deforms the first engagement part and guides the first engagement part along the slanted face, and
a hook part for latching the first engagement part.

5. The coil device according to claim 1, wherein the first engagement part is arranged on the end wall having the end wall opening.

6. The coil device according to claim 5, wherein
the first engagement part comprises claw-like parts projecting inwards to the end wall opening from an opening edge of the end wall, and
the claw-like parts are positioned on both sides in a width direction of the through hole of the tubular part.

7. The coil device according to claim 6, wherein
the end wall opening is separated into a main opening and a sub-opening by the claw-like parts, and
the middle leg is inserted into the main opening.

8. The coil device according to claim 1, wherein the first engagement part is fixed to the bobbin and to the core using an adhesive.

9. The coil device according to claim 1, wherein
the bobbin comprises a terminal block for installing a terminal connected to a lead part pulled out from a coil part of the wire, and
the cover comprises a terminal block cover part covering the terminal block.
